(19) United States
(12) Patent Application Publication
(10) Pub. No.: US 2023/0394631 A1
(43) Pub. Date: Dec. 7, 2023

(54) NOISE2SIM - SIMILARITY-BASED SELF-LEARNING FOR IMAGE DENOISING

(71) Applicant: Rensselaer Polytechnic Institute, Troy, NY (US)

(72) Inventors: Ge Wang, Loudonville, NY (US); Chuang Niu, Troy, NY (US)

(73) Assignee: Rensselaer Polytechnic Institute, Troy, NY (US)

(21) Appl. No.: 18/035,571

(22) PCT Filed: Nov. 5, 2021
(86) PCT No.: PCT/US21/58170

§ 371 Date: May 5, 2023

(51) Int. Cl. G06T 5/00

(52) U.S. Cl. CPC G06T 5/002; G06T 2207/20081; G06T 2207/20084; G06T 2207/10056; G06T 2207/10081; G06T 2207/10076; G06T 2207/10088

(57) ABSTRACT

One embodiment provides a method of training an artificial neural network (ANN) for denoising. The method includes generating, by a similarity module, a respective set of similar elements for each noisy input element of a number of noisy input elements included in a single noisy input data set. Each noisy input element includes information and noise. The method further includes generating, by a sample pair module, a plurality of training sample pairs. Each training sample pair includes a pair of selected similar elements corresponding to a respective noisy input element. The method further includes training, by a training module, an ANN using the plurality of training sample pairs. Each set of similar elements is generated prior to training the ANN. The plurality of training sample pairs is generated during training the ANN. The training is unsupervised.

### CROSS REFERENCE TO RELATED APPLICATION(S)

This application claims the benefit of U.S. Provisional Application No. 63/110,347, filed Nov. 6, 2020, and U.S. Provisional Application No. 63/254,993, filed Oct. 12, 2021, which are incorporated by reference as if disclosed herein in their entireties.

### GOVERNMENT LICENSE RIGHTS

This invention was made with government support under award numbers EB026646, CA233888, CA237267, HL151561, CA264772 and EB031102, all awarded by the National Institutes of Health. The government has certain rights in the invention.

### FIELD

The present disclosure relates to image denoising, in particular to, similarity-based self-learning for image denoising.

### BACKGROUND

Real-world images may generally be corrupted by various noises. Deep learning techniques, for example using artificial neural networks (ANNs), may be used for denoising such real-world images. Generally, prior to their use, ANNs are trained using paired training data. The training data typically includes pairs of noisy input data and labeled output data (e.g., clean output data), corresponding to the target real-world images. The paired training data may be expensive to obtain or, in some cases, may be unavailable.

### SUMMARY

In some embodiments, there is provided a method of training an artificial neural network (ANN) for denoising. The method includes generating, by a similarity module, a respective set of similar elements for each noisy input element of a number of noisy input elements included in a single noisy input data set. Each noisy input element includes information and noise. The method further includes generating, by a sample pair module, a plurality of training sample pairs. Each training sample pair includes a pair of selected similar elements corresponding to a respective noisy input element. The method further includes training, by a training module, an ANN using the plurality of training sample pairs. Each set of similar elements is generated prior to training the ANN. The plurality of training sample pairs is generated during training the ANN. The training is unsupervised.

In some embodiments of the method, at least some of the noise is independent. In some embodiments of the method, at least some of the noise is correlated.

In some embodiments of the method, each set of similar elements includes a number, k, nearest similar elements. In some embodiments of the method, k is equal to eight.

In some embodiments of the method, the noisy input data corresponds to noisy image data.

In some embodiments, the method further includes randomly and independently selecting, by the sample pair module, each similar element in each pair.

In some embodiments of the method, the noisy input data is selected from the group including: two-dimensional (2D) natural images, 2D microscopy images, three-dimensional (3D) low-dose (LD) CT (computed tomography) images, photon-counting micro-CT images, and four-dimensional (4D) spectral CT images, seismic data, and k-space data for magnetic resonance imaging (MRI).

In some embodiments of the method, each similar element corresponds to a respective image patch.

In some embodiments, there is provided a computer readable storage device having stored thereon instructions that when executed by one or more processors result in the following operations including: any embodiment of the method.

In some embodiments, there is provided a training system for training an artificial neural network (ANN). The system includes a similarity module, a sample pair module, and a training module. The similarity module is configured to generate a respective set of similar elements for each noisy input element of a number of noisy input elements included in a single noisy input data set. Each noisy input element includes information and noise. The sample pair module is configured to generate a plurality of training sample pairs. Each training sample pair includes a pair of selected similar elements corresponding to a respective noisy input element. The training module is configured to train an ANN using the plurality of training sample pairs. Each set of similar elements is generated prior to training the ANN. The plurality of training sample pairs is generated during training the ANN. The training is unsupervised.

In some embodiments of the system, at least some of the noise is independent.

In some embodiments of the system, at least some of the noise is correlated.

In some embodiments of the system, each set of similar elements includes a number, k, nearest similar elements. In some embodiments of the system, k is equal to eight.

In some embodiments of the system, the noisy input data corresponds to noisy image data.

In some embodiments of the system, the sample pair module is configured to randomly and independently select each similar element in each pair.

In some embodiments of the system, the noisy input data is selected from the group including: two-dimensional (2D) natural images, 2D microscopy images, three-dimensional (3D) low-dose (LD) CT (computed tomography) images, photon-counting micro-CT images, and four-dimensional (4D) spectral CT images, seismic data, and k-space data for magnetic resonance imaging (MRI).

In some embodiments of the system, each similar element corresponds to a respective image patch.

In some embodiments of the system, the ANN is a deep ANN.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 illustrates a functional block diagram of a training system for similarity-based training of an artificial neural network (ANN) for image denoising, according to several embodiments of the present disclosure; and

FIG. 2 is a flowchart of ANN training operations for similarity-based self-learning for image denoising, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

It may be appreciated that symmetry and similarity are ubiquitous in physical science(s) and images of the world. A method and/or system, according to the present disclosure, may be configured to exploit at least such similarity in order to train an ANN for denoising noisy input data, e.g., noisy image data. In an embodiment, unsupervised deep learning, based, at least in part, on similar features, may be used to suppress independent and/or correlated image noise. As used herein, “unsupervised” corresponds to training an ANN using a single noisy image as a source of both input data and output data for the training data. In an embodiment, the training data may include non-local mean data, as will be described in more detail below. An ANN trained according to the present disclosure may then be configured for a particular denoising application. In other words, the trained ANN may be configured to denoise images including, but not limited to, two-dimensional (2D) natural images (e.g., gray scale, color, and/or smartphone images), 2D microscopy images, three-dimensional (3D) low-dose (LD) CT (computed tomography) images, photon-counting micro-CT images, and/or four-dimensional (4D) spectral CT images. It is contemplated that similar training techniques may be applied to other denoising applications (e.g., seismic data in geophysics, k-space data for magnetic resonance imaging (MRI), etc.), consistent with the present disclosure.

Generally, this disclosure relates to a method and system for similarity-based self-learning for image denoising. The method and/or system may be referred to as “Noise2Sim”, where “Sim” corresponds to “similar”. As used herein, “self-learning” corresponds to unsupervised training of an artificial neural network (ANN). Additionally or alternatively, the method and system may be used for training an ANN for denoising input data other than image data, within the scope of the present disclosure.

Generally, the method and/or system is configured to receive noisy input data. As used herein, “noisy input data” corresponds to input data that contains information and noise. The noise may be independent, correlated and/or a combination thereof. The noisy input data may contain a plurality of elements. In one nonlimiting example, for noisy 2D image data, each element may correspond to a pixel. However, this disclosure is not limited in this regard.

The method and/or system may then be configured to identify one or more similar elements for each of at least some input elements in the noisy input data. As used herein, “reference element” corresponds to the input element for which the similar element(s) are identified. Similar elements may be identified based, at least in part, on a respective portion of the noisy input data, related to the each input element. In one nonlimiting example, the input element may correspond to a central pixel of an image patch and the image patch may correspond to the portion of noisy input data. However, this disclosure is not limited in this regard. Similarity may be determined based, at least in part, on a relationship between a first portion and a second portion of the noisy input data. The first portion is related to the reference input element and the second portion is related to a second input element. The first and second elements and thus, the first portion and the second portion may be non-local, as described herein.

In some embodiments, the first portion of the noisy input data may correspond to a first sub-image and the second portion of the noisy input data may correspond to a second sub-image. Both sub-images may be included in a same noisy input image. Sub-images may include, but are not limited to, a pixel, a two-dimensional image patch containing a plurality of pixels, a voxel, a three-dimensional image sub-volume containing a plurality of voxels, etc. In some embodiments, each portion of noisy input data may correspond to noisy data other than image data.

A respective set of similar elements may then be generated for each of at least some selected noisy input elements. The set of similar elements may be generated as a preprocessing operation, prior to training the ANN. The selected noisy input element is configured to correspond to the reference element. The respective set of similar elements is configured to include at least some of the identified similar elements. A plurality of training sample pairs may then be generated for each noisy input element. The training sample pairs may be generated “on-the-fly” during training. Each training sample pair is configured to include two elements selected from the group that includes the reference element and the corresponding set of similar elements.

An ANN may then be trained using the plurality of training pairs with each pair including two selected similar portions of the noisy input data. Advantageously, the ANN may be trained using only the noisy input data, thus avoiding acquiring corresponding labeled target output data. The trained ANN may then be used to denoise the noisy input data and/or other noisy data.

In the following, application of Noise2Sim to image data is generally described. It should be noted that the description applies to noisy input data other than image data, within the scope of the present disclosure. Image data is described by way of example and not of limitation.

Generally, a noisy image xᵢ may be decomposed into two parts: xᵢ=sᵢ+nᵢ, that may be generated from a joint distribution p(s, n)=p(s)p(n|s), where sᵢ and nᵢ are a clean signal and an associated noise, respectively, for signal i of one or more signals. A deep denoising method is configured to learn a network function to recover the clean signal sᵢ from the noisy signal xᵢ, i.e., yᵢ=ƒ(xᵢ; θ), where ƒ denotes a network function with a vector of parameters to be optimized. In a supervised training process, for example, each noisy image xᵢ is associated with a corresponding clean image sᵢ as a corresponding target. Let θ_{c} correspond to network (i.e., ANN) parameters optimized with paired noise-clean data, θ_{c} may then be defined as:

$${θ}_{c} = \begin{matrix}argmin \\ θ\end{matrix} \frac{1}{{N}_{c}} {\sum }_{i = 1}^{{N}_{c}} {‖ f ( {s}_{i} + {n}_{i} ; θ ) - {s}_{i} ‖}_{2}^{2}$$

where N_{c} corresponds to the number of images. In one nonlimiting example, a mean squared error (MSE) may be used as a corresponding loss function. However, this disclosure is not limited in this regard.

In an embodiment, Noise2Sim is configured to exploit symmetry and similarity generally present in the physical world. Such similarity may then yield similar sub-images, including, but not limited to, similar image pixels, patches, slices, volumes and/or tensors embedded within and across of images in different dimensionalities. Noise2Sim, may then be configured to train a deep network (i.e., deep ANN) without collecting paired noisy or clean target data. Noise2Sim is configured to replace a clean or noisy target with a similar target for training the denoising network, such that noises are suppressed to enhance information signals faithfully. Specifically, given a noisy image, a set of similar sub-images may be constructed. The set of similar sub-images may be denoted as: xᵢ=sᵢ+nᵢ and \hat{x}ᵢ=sᵢ+δᵢ+\hat{n}ᵢ, where δᵢ is the difference between clean signal components in the similar sub-images, and nᵢ and \hat{n}ᵢ are two different noise realizations. Let θₛ be a vector of network parameters optimized with constructed similar pairs of data. θₛ may be determined by minimizing a loss function, e.g., loss function:

$${θ}_{s} = \begin{matrix}argmin \\ θ\end{matrix} \frac{1}{{N}_{s}} {\sum }_{i = 1}^{{N}_{s}} {‖ f ( {s}_{i} + {n}_{i} ; θ ) - ( {s}_{i} + {δ}_{i} + {\hat{n}}_{i} ) ‖}_{2}^{2}$$

where Nₛ denotes a number of noisy similar image pairs.

It may be appreciated based, at least in part, on two zero conditional expectations: [symbol] [\hat{n}ᵢ|sᵢ+nᵢ]=0 and [symbol] [δᵢ|sᵢ+nᵢ]=0, ∀i, that, in the limit, as Nₛ→∞, θₛ=θ_{c}, i.e., lim_{N}_{ₛ}_{→∞} θₛ=θ_{c}. A first condition, i.e., [symbol] [n′ᵢ|sᵢ+nᵢ]=0, may be termed zero-mean conditional noise (ZCN). This first condition is satisfied if similar sub-images have independent and zero-mean noises, i.e., [symbol] [n′ᵢ|sᵢ+nᵢ]= [symbol] [n′ᵢ]=0. It may be further appreciated that as direct current (DC) offsets in imaging systems are usually calibrated well, the expectation of observations is the real signal, meaning that the noise component has a zero mean. If noises of all pixels are independent from each other, the ZCN condition is directly satisfied, and the independent noises may be suppressed with Noise2Sim. In the case of correlated noises, if the distance between two sub-images is greater than a correlation length of noise, their noise components tend to be independent. Thus, by learning between such nonlocal similar sub-images, it is feasible for the denoising network (i.e., denoising ANN) to perform well on correlated noises. It should be noted that there are no specific assumptions on the noise distribution, thus, Noise2Sim may be adapted to process different noise distributions. A second condition, i.e., [symbol] [δᵢ|sᵢ+nᵢ]=0, may be termed a zero-mean conditional discrepancy (ZCD). In practice, although the ZCD condition may not be exactly satisfied, it is a very good approximation that may be achieved by searching the similar sub-images.

Thus, a set of similar sub-images may be searched from noisy images, with the ZCN and ZCD conditions satisfied. The denoising network may then be optimized with the constructed similar training samples in a self-learning manner. Formally, a similar training set may be defined as {(xᵢ, \hat{x}ᵢ)|S(T(xᵢ), T(\hat{x}ᵢ))}, where T is a transform of each sub-image, and S is a metric to identify whether two sub-images are similar or not. T and S may take different forms, depending on domain-specific priors. For example, similar sub-images may correspond to similar pixels/patches in 2D images, slices in 3D images, and volumes in 4D images.

In an embodiment, a searching technique may be selected based, at least in part, on a particular denoising application. Denoising applications may include, but are not limited to, 2D images with independent noise, and/or correlated noise, and LDCT and photon-counting spectral micro-CT images, etc., as described herein.

In a first example, for a 2D image that includes independent noise, each sub-image x i may be defined as a pixel. Similar images may be constructed by replacing each selected original pixel with a respective corresponding searched similar pixel during training. In this first example, T may correspond to the identity function. In other words, transformations may generally not be applied to image pixels. It may be appreciated that a transformation may be used to reduce a variance of similarity estimation caused by noises. For the similarity estimation S, a k-NN (i.e., k nearest neighbor) strategy may be implemented so that each pixel may be matched with k nearest similar pixels in terms of a Euclidean distance between their surrounding patches. At the pixel level, for each reference pixel x(u, v) with its coordinates (u, v) in a given noisy image x, the reference pixel's k nearest pixels over the whole image may be determined. A distance between two pixels x(u₁, v₁) and x(u₂, v₂) is defined as the Euclidean distance between their associated patches; i.e., ∥S(u₁, v₁)−S(u₂, v₂)∥₂, where S(u, v) may denote a patch that is determined by a patch size and a center pixel x(u, v). In one nonlimiting example, the image patch S(u, v) may be square. However, this disclosure is not limited in this regard. Thus, each position in the image may have a corresponding set of k+1 similar pixels (+1 in this context means the reference pixel is included in the set of similar pixels), denoted as [symbol] (u, v)={x(u, v), x¹(u, v), . . . , xₖ(u, v)}, where x^{j}(u, v) denotes the j-th nearest pixel relative to x(u, v). Based, at least in part, on the similar pixel sets, a similar noisy image may be constructed by replacing each original pixel x(u, v) with a similar pixel randomly selected from 0.7V(u, v), the set of similar pixels. During training, a pair of similar images may then be independently constructed in each iteration.

It may be appreciated that the number of all possible similar images for each given image is (k+1)^{H×W} where H and W represent the image height and width, respectively. It may be further appreciated that if all similar images are prepared before training or on-the-fly during training, the memory space or computational time may be unacceptable. To avoid over-consumption of memory space and excessive computational time, the Noise2Sim training process may be split into two parts. In a first part, k-nearest similar images may be generated from a single noisy image. The k-nearest similar images may be obtained by sorting the k-nearest similar pixels for each pixel location. In other words, the j-th nearest image is [x^{j}(u, v)]_{H×W}. In a second part, with these k+1 similar images, a pair of similar images may be randomly and independently constructed, on-the-fly, during training. The time searching for these similar images may be acceptable in the first part, using, for example, an optimized algorithm on a graphics processing unit (GPU). The construction of paired similar images takes a relatively small amount of time in the second part. It may be appreciated that, since noise may harm the estimation of signal similarities, the denoised image may be used to improve the computation of the similarity between image patches, and then the Noise2Sim training may be performed again, and may be iterated.

In a second example, for a 2D image that includes correlated noises, the 2D image may be divided into a set of small patches by sliding window having a height and a width (e.g., in pixels), with a stride of a number of pixels. In one nonlimiting example, the window size may be 16×16, and the stride may be equal to 4. However, this disclosure is not limited in this regard. These small patches, i.e., windows, may be regarded as sub-images, and the deep denoising network is optimized by learning to map between similar patches.

In an embodiment, to evaluate the similarity between patches that are corrupted by correlated noises, the patches may be first converted into the transform domain and the high-frequency components may be removed. In one nonlimiting example, the transform function T may be implemented as a discrete cosine transform. However, this disclosure is not limited in this regard. It is contemplated that an advanced transform may be implemented as the transform function T. The similarity may then be determined by the Euclidean distance between transformation coefficients. For each reference sub-image, a number of nearest patches may be globally searched to construct the training set. In one nonlimiting example, the number of nearest patches may be set to 8. During training, two similar patches may be randomly selected to train the denoising network.

For example, Noise2Sim, as described herein, may be applied to LDCT CT images and/or photon-counting micro-CT images. A similar image of a reference slice from its neighbor slices may be searched, i.e., [i−k, i+k]^{th} slices, k defines the searching range. In particular, some pixels/vectors at the same in-plane location but on different slices may not be similar to each other when they represent different tissues or organs. These dissimilar parts may compromise the zero-mean conditional discrepancy condition, and thus may be excluded from training samples. Specifically, a pair of similar LDCT images or spectral CT images may be denoted as xᵢ, xⱼ∈R^{H×W×C}, where H, W, C denote height, width, and channel of CT images, C=1 for LDCT images, and i, j are the slice indices, j∈[i−k, i+k]. For each pair of vectors xᵢ(u, v, :), xⱼ(u, v, :)∈R_{C} at the same spatial location (u, v), their surrounding patches may be utilized to determine the similarity. The patches of these two vectors may share the same spatial coordinates S(u, v) that are determined by the spatial center (u, v) and the patch size s×s. Formally, the distance map d∈R^{H×W} between xᵢ and xⱼ may be defined as:

$$d ( u , v ) = \frac{1}{{s}^{2}} \sqrt{{\sum }_{c = 1}^{c} {( {\sum }_{( p , q ) ∈ S ( u , v )} ( {x}_{i} ( p , q , c ) - {x}_{j} ( p , q , c ) ) )}^{2}}$$

In practice, the inner summation can be computed by convolution with an s×s kernel filled with ones. Then, the dissimilar mask m may be computed as:

$$m ( u , v ) = \{ \begin{matrix}1 & d ( u , v ) > {d}_{t h} \\ 0 & otherwise\end{matrix}$$

where the dₜₕ is a predefined threshold. In one nonlimiting example, the patch size may be empirically set to s=7 and the threshold dₜₕ=40 in HU. However, this disclosure is not limited in this regard.

An apparatus, method and/or system, according to the present disclosure, are configured to receive noisy input data, e.g., a noisy image, to generate a respective set of similar elements for each noisy input element, generate a plurality of training sample pairs using the similar elements and to train an ANN. The sets of similar elements may be generated as a preprocessing operation. The training sample pairs may then be constructed, on-the-fly, during training. Thus, an ANN configured to denoise noisy input data may be trained, unsupervised, based, at least in part, on a single noisy input data set.

One embodiment provides a method of training an artificial neural network (ANN) for denoising. The method includes generating, by a similarity module, a respective set of similar elements for each noisy input element of a number of noisy input elements included in a single noisy input data set. Each noisy input element includes information and noise. The method further includes generating, by a sample pair module, a plurality of training sample pairs. Each training sample pair includes a pair of selected similar elements corresponding to a respective noisy input element. The method further includes training, by a training module, an ANN using the plurality of training sample pairs. Each set of similar elements is generated prior to training the ANN. The plurality of training sample pairs is generated during training the ANN. The training is unsupervised.

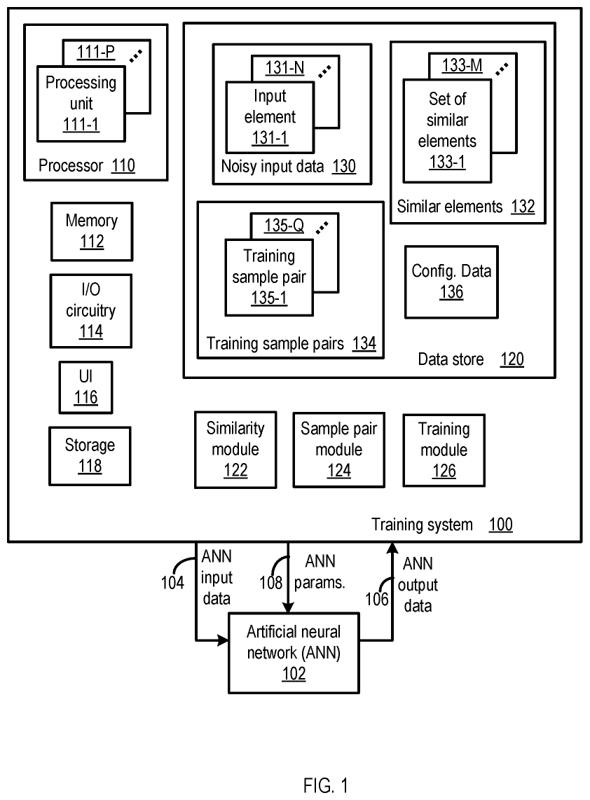

FIG. 1 illustrates a functional block diagram of a training system 100 for similarity-based training an artificial neural network (ANN) for image denoising, according to several embodiments of the present disclosure. Training system 100 may be coupled to ANN 102 and is configured to provide ANN input data 104 to ANN 102 and to receive corresponding ANN output data 106 from ANN 102. During training, training system 100 is configured to provide ANN parameters 108 to, and/or adjust ANN parameters 108 for, ANN 102 based, at least in part, on ANN input data 104 and based, at least in part, on ANN output data 106.

Training system 100 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Training system 100 includes a processor 110, a memory 112, input/output (I/O) circuitry 114, a user interface (UI) 116, and storage 118. Training system 100 may include a data store 120, a similarity module 122, a sample pair module 124, and a training module 126.

Processor 110 may include one or more processing units 111-1, . . . , 111-P and is configured to perform operations of training system 100, e.g., operations of similarity module 122, sample pair module 124, and/or training module 126. Memory 112 may be configured to store at least a portion of data store 120, and data associated with similarity module 122, sample pair module 124, and/or training module 126. I/O circuitry 114 may be configured to provide wired and/or wireless communication functionality for training system 100. UI 116 may include a user input device (e.g., keyboard, mouse, microphone, touch sensitive display, etc.) and/or a user output device, e.g., a display. Storage 118 may be configured to store a portion or all of data store 120.

Data store 120 may be configured to store noisy input data 130, similar elements 132, training sample pairs 134 and configuration data 136. Noisy input data 130 includes a plurality of input elements 131-1, . . . , 131-N; similar elements 132 includes a plurality of sets of similar elements 133-1, . . . , 133-M; and training sample pairs 134 includes a plurality of training sample pairs 135-1, . . . , 135-Q. Configuration data 136 may include, but is not limited to, a number of similar elements included in a set, a number of training samples included in a set, a sub-image (e.g., patch) size, a similarity function, a loss function, an ANN architecture identifier, etc.

ANN 102 corresponds to a denoising network and may include, but is not limited to, a convolutional neural network (CNN), a deep CNN, a multilayer perceptron (MLP), a generative adversarial network (GAN), etc. ANN 102 may further correspond to one or more of a variety of neural network architectures. A particular architecture may be selected based, at least in part, on the denoising application. Training system 100 may be configured to train each of a variety of ANNs, having a variety of architectures.

Denoising applications, and thus noisy input data 130, may include, but are not limited to, two-dimensional (2D) natural images (e.g., gray scale, color, and/or smartphone images), 2D microscopy images, three-dimensional (3D) low-dose CT (computed tomography) images, photon-counting micro-CT images, and/or four-dimensional (4D) spectral CT images, seismic data in geophysics, k-space data for magnetic resonance imaging (MRI), etc.

In operation, training system 100 may be configured to receive noisy input data and to store the noisy input data in data store 120, as noisy input data 130. The noisy input data 130 may include a plurality of input elements 131-1, . . . , 131-N. Each input element may include an input data portion and a noise portion. The noise may be independent, correlated and/or a combination thereof. A type of element is related to a type of input data 130. For example, for a two-dimensional (2D) image, each input element 131-1, . . . , 131-N may correspond to a respective pixel in the 2D image. In another example, for a 2D image, each element may correspond to a sub-image and/or an image patch that includes a plurality of pixels. In another example, for 3D input data, each input element 131-1, . . . , 131-N may correspond to a voxel. Thus, the noisy input data 130 may include a variety of types of data.

Training system 100, e.g., similarity module 122, may be configured to generate a set of similar elements for each input element (i.e., reference element) 131-1, . . . , 131-N of the noisy input data 130. Generating the set of similar elements for each noisy input element may include searching similar elements, e.g., pixels, for each element in the noisy input data. Generating the set of similar elements for each noisy input element may further include sorting the similar element to generate a set of k similar elements, e.g., pixels, for each element in the noisy input data. The searching and sorting similar elements correspond to searching for k-nearest similar image portions (e.g., patches) for the reference element (and corresponding image portion). The operations may be repeated for each element in the noisy input data.

In one nonlimiting example, a similarity between two elements may be measured with a Euclidean distance between the two portions of the noisy input data whose centers correspond to the two elements. For example, for elements that are pixels, the portions of noisy input data may correspond to sub-images (e.g., image patches). The sub-images may have a shape, e.g., square. The central pixels of similar image patches may then be defined as similar pixels with respect to a reference pixel.

In one nonlimiting example, in the search process, a size-fixed square patch window may be translated over a noisy image of interest to find similar pixels. The patch size may affect the accuracy of similarity estimation. It may be appreciated that the denoising performance of smaller patch sizes may be better for lower noise levels while the denoising performance of larger patch sizes may be better for higher noise levels. It is contemplated that relatively more contextual information may be used to estimate the similarity accurately when pixels are heavily corrupted by noise.

An amount of error may be related to the number of selected similar pixels, k. In other words, there is a trade-off between the error term and the number of training samples. It may be appreciated that increasing the number of similar pixels may increase error term values, while decreasing this number will decrease the amount of information on self-similarity, and may increase noise residual in the denoised image. In other words, with a larger k, the noise dependence of similar pixels may become weaker with similarity decrease and thus harder to detect. In one nonlimiting example, k=8 may provide a relatively good balance. In other examples, k may be more than 8 or less than 8. Overall, Noise2Sim is configured to manage the denoising level with the neighborhood parameter k. In practice, the parameter k may be adjusted according to specific settings or down-stream tasks. For example, k may be optimized if image quality can be quantitatively modeled, such as with a neural network and/or a Gram matrix.

In an embodiment, generating the set of k-nearest similar images from the noisy input image may be performed as a preprocessing operation. The k-nearest similar images may be obtained by sorting the k-nearest similar pixels for each element in the noisy input data. A plurality of training sample pairs may then be generated during training. Training samples for Noise2Sim may then be randomly and independently selected from the set of similar k+1 pixels (where +1 means the reference pixel is included). Therefore, the set of training samples for Noise2Sim may be relatively large.

Training system 100, e.g., sample pair module 124, may be configured to generate a plurality of training sample pairs. Each training sample pair is configured to contain two similar elements. A first similar element corresponds to an input to the ANN to be trained and a second similar element corresponds to an output (i.e., target) of the ANN. Each training sample pair is configured to correspond to a respective noisy input element. Generating the plurality of training sample pairs includes pairing two similar elements to form each training sample pair. The plurality of training sample pairs may thus include a respective training sample pair for each of the at least some of the input elements 131-1, . . . , 131-N. It may be appreciated that sample pair module 124 may be configured to repeat generating the plurality of training sample pairs, using at least some different similar element information, during training.

Pairing two similar elements includes selecting two similar elements from the set of k+1 similar images, generated at described herein. Pairing may be implemented in a variety of techniques. A first technique includes pairing an original noisy input image portion with a randomly constructed similar image portion as a label (i.e., target). A second technique may include the output of the first technique with the similar elements reversed so that the input to the ANN is the randomly constructed similar image portion and the label is the original noisy input image portion. A third technique may include pairing the k sorted similar images without pixel-wise randomization. A fourth technique may include pairing randomly similar images that were randomly and independently constructed element-wise (e.g., pixel-wise). It may be appreciated that the fourth technique may achieve a relatively better denoising performance compared to the other techniques. It may be further appreciated that the fourth method may represent diverse samples relatively more effectively without significant bias. Advantageously, the fourth technique yields a greater number of possible image pairs (i.e., (k+1)^{2H×W} versus (k+1)^{H×W}) relative to the other techniques, and may thus provide relatively better performance.

Training system 100, e.g., training module 126, may then be configured to train ANN 102 using the plurality of training sample pairs.

It may be appreciated that an estimate of similarity between image patches may be compromised in a noisy image. Such an estimate may be improved in a denoised image produced by a trained denoising model. In an embodiment, the Noise2Sim idea may be repeatedly applied to refine the resultant denoising model. By doing so, the similarity measures may be gradually improved, leading to a superior denoising performance.

Thus, an apparatus, method and/or system, according to the present disclosure, are configured to receive noisy input data, e.g., a noisy image, to generate a respective set of similar elements for each noisy input element, generate a plurality of training sample pairs using the similar elements and to train an ANN. The sets of similar elements may be generated as a preprocessing operation. The training sample pairs may then be constructed, on-the-fly, during training. Thus, an ANN configured to denoise noisy input data may be trained, unsupervised, based, at least in part, on a single noisy input data set.

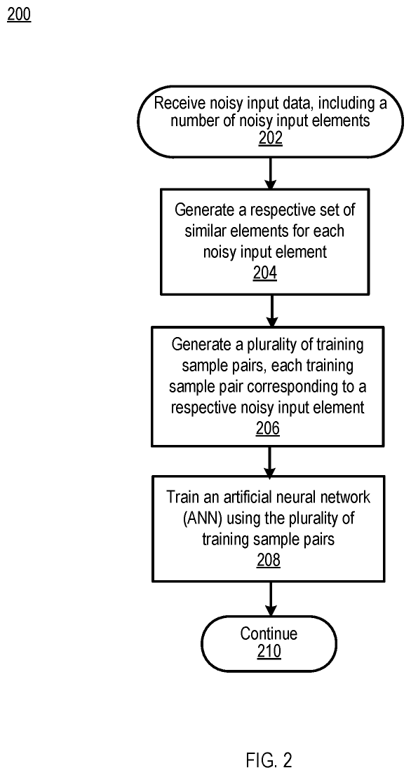

FIG. 2 is a flowchart 200 of ANN training operations for similarity-based self-learning for image denoising, according to various embodiments of the present disclosure. In particular, the flowchart 200 illustrates training an ANN using noisy input data. The operations may be performed, for example, by the training system 100 (e.g., similarity module 122, sample pair module 124 and/or training module 126) of FIG. 1.

Operations of this embodiment may begin with receiving noisy input data at operation 202. Operation 204 includes generating a respective set of similar elements for each noisy input element. Generating the respective set of similar elements for each noisy input may be performed as a preprocessing operation, prior to training the ANN. Operation 206 includes generating a plurality of training sample pairs. The training sample pairs may be generated during training. Each training sample pair corresponds to a respective noisy input element.

An ANN may be trained using the plurality of training sample pairs at operation 208. Program flow may then continue at operation 210.

Thus, an ANN may be trained using noisy input data. In an embodiment, the noisy input data may correspond to a medical image.

In the foregoing, training the ANN is described with respect to noisy image data. However, it is contemplated that such techniques may be applied to other noisy data, within the scope of the present disclosure. Other forms of noisy data may include, but are not limited to, MRI k-space data, CT sinogram data, noisy non-image data, etc.

As a general unsupervised denoising approach, Noise2Sim may be adapted to other domains, in addition or alternatively to the image domain. Such other domains may include, but are not limited to, seismic data in geophysics and k-space data for MRI. A deeper analysis of domain-specific data may help leverage similar data and achieve superior performance. For example, the LDCT denoising performance may be upgraded using a dual domain denoising network with similarity matches performed in each of the sinogram domain and the image domain. It is contemplated that, due, in part, to its simplicity and efficiency, Noise2Sim, as described herein, may be incorporated into additional or alternative frameworks as an intermediate step or a constraint. In one nonlimiting example, Noise2Sim may be used as a deep prior in the CT image reconstruction process.

Additionally or alternatively, the Noise2Sim technique, as described herein, may be extended from multiple views, such as using finer similarity measures between pixels/patches, extracting more self-similarity information, incorporating the Bayesian reasoning, and/or removing correlated noises in specific applications.

The Euclidean distance, as described herein, may be used to measure the similarity between patches. Additionally or alternatively, relatively more advanced measures may be used for the same purpose at an increased computational cost. Self-similarity exhibits itself in many ways: direct as measured by the Euclidean distance, indirect through scaling, reflection and rotation, or even hidden in a transform domain. Hence, Noise2Sim may be configured for an optimized performance in a task-specific fashion, consistent with the present disclosure.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 112 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A method of training an artificial neural network (ANN) for denoising, the method comprising:
generating, by a similarity module, a respective set of similar elements for each noisy input element of a number of noisy input elements included in a single noisy input data set, each noisy input element comprising information and noise;
generating, by a sample pair module, a plurality of training sample pairs, each training sample pair comprising a pair of selected similar elements corresponding to a respective noisy input element; and
training, by a training module, an ANN using the plurality of training sample pairs,
each set of similar elements generated prior to training the ANN, the plurality of training sample pairs generated during training the ANN, and wherein the training is unsupervised.

2. The method of claim 1, wherein at least some of the noise is independent.

3. The method of claim 1, wherein at least some of the noise is correlated.

4. The method of claim 1, wherein each set of similar elements comprises a number, k, nearest similar elements.

5. The method of claim 1, wherein the noisy input data corresponds to noisy image data.

6. The method of claim 1, further comprising randomly and independently selecting, by the sample pair module, each similar element in each pair.

7. The method of claim 4, wherein k is equal to eight.

8. The method of claim 1, wherein the noisy input data is selected from the group comprising: two-dimensional (2D) natural images, 2D microscopy images, three-dimensional (3D) low-dose (LD) CT (computed tomography) images, photon-counting micro-CT images, and four-dimensional (4D) spectral CT images, seismic data, and k-space data for magnetic resonance imaging (MRI).

9. The method of claim 3, wherein each similar element corresponds to a respective image patch.

10. A computer readable storage device having stored thereon instructions that when executed by one or more processors result in the following operations comprising: the method according to claim 1.

11. A training system for training an artificial neural network (ANN), the system comprising:
a similarity module configured to generate a respective set of similar elements for each noisy input element of a number of noisy input elements included in a single noisy input data set, each noisy input element comprising information and noise;
a sample pair module configured to generate a plurality of training sample pairs, each training sample pair comprising a pair of selected similar elements corresponding to a respective noisy input element; and
a training module configured to train an ANN using the plurality of training sample pairs,
each set of similar elements generated prior to training the ANN, the plurality of training sample pairs generated during training the ANN, and wherein the training is unsupervised.

12. The system of claim 11, wherein at least some of the noise is independent.

13. The system of claim 11, wherein at least some of the noise is correlated.

14. The system of claim 11, wherein each set of similar elements comprises a number, k, nearest similar elements.

15. The system of claim 11, wherein the noisy input data corresponds to noisy image data.

16. The system according to claim 11, wherein the sample pair module is configured to randomly and independently select each similar element in each pair.

17. The system of claim 14, wherein k is equal to eight.

18. The system according to claim 11, wherein the noisy input data is selected from the group comprising: two-dimensional (2D) natural images, 2D microscopy images, three-dimensional (3D) low-dose (LD) CT (computed tomography) images, photon-counting micro-CT images, and four-dimensional (4D) spectral CT images, seismic data, and k-space data for magnetic resonance imaging (MRI).

19. The system of claim 13, wherein each similar element corresponds to a respective image patch.

20. The system according to claim 11, wherein the ANN is a deep ANN.
